(19) United States
(12) Patent Application Publication
(10) Pub. No.: US 2020/0396067 A1
(43) Pub. Date: Dec. 17, 2020

(54) QUANTUM PROTECTION OF TELEMETRY TRACKING AND COMMAND LINKS

(71) Applicant: ARQIT LIMITED, Bedford (GB)

(72) Inventor: Trevor Barker, Bedford (GB)

(21) Appl. No.: 16/772,452

(22) PCT Filed: Dec. 13, 2018
(86) PCT No.: PCT/GB2018/000155

§ 371 Date: Jun. 12, 2020

(30) Foreign Application Priority Data
Dec. 13, 2017 (GB) 1720763.0

(51) Int. Cl. H04L 9/08; H04B 7/185; H04B 10/70

(52) U.S. Cl. CPC H04L 9/0858; H04L 9/0894; G06N 10/00; H04B 10/70; H04B 7/18519

(57) ABSTRACT

A control apparatus for a satellite comprises a command generator to generate TT&C instructions for the satellite. The control apparatus further comprises an encryptor to encrypt TT&C instructions using a common quantum encryption key shared with the satellite and a transmitter to transmit the encrypted TT&C instructions to the satellite. A satellite comprises a command and telemetry subsystem to generate TT&C information for the satellite. The satellite further comprises an encryptor to encrypt TT&C instructions using a common quantum encryption key shared with the control apparatus and a transmitter to transmit the encrypted TT&C instructions to the control apparatus.

### FIELD OF DISCLOSURE

The present disclosure relates to Telemetry, Tracking and Command (TT&C) communication for satellites. More particularly, the disclosure relates to protection of TT&C links between a satellite and a Ground Station using Quantum Key Distribution (QKD).

### BACKGROUND

Cryptography is the field of constructing and analysing protocols that prevent third parties from reading private messages shared by two collaborating parties. The process of encryption generally involves the sender (transmitter) of a message (conventionally referred to as “Alice”) applying a cryptographic algorithm to data within the message using a secret, shared key. On receipt of the encrypted message, the recipient (receiver; conventionally termed “Bob”) decrypts the message by reversing the cryptographic algorithm using the same shared key (common key) to reveal the original message.

In one classical example of encryption, Alice and Bob each have a copy of the same one-time key pad (i.e. a physical book with a number of keys that are to be used once and then discarded). There will be an agreed method of determining which key within the pad is to be used to decrypt a message. For example, it could be established that a specific key within the pad will be used for the first encryption/decryption, and that the key is discarded after decrypting a first message thereby automatically indicating that the next key in the pad will used to decrypt a second message. The keys can be discarded in such a manner until all the keys in the pad are used. Of course, in such a system, if an adversary (sometimes known as an ‘eavesdropper’ or simply “Eve”) can procure the pad, they drastically reduce the amount of time it will take to decrypt any encrypted messages they intercept.

One of the biggest problems in cryptography is ensuring that the key remains secret when it is being shared. In classical cryptography, there are many ways in which an adversary (‘Eve’) might be able to obtain knowledge about the message or key without being detected. For example, the skilled person will be aware of ‘cryptanalysis’, which includes direct attacks against the encryption algorithm (also termed, ‘brute force’ attacks) and attacks against the system implementing the encryption (also termed, ‘side-channel’ attacks). Indeed, classical encryption techniques will become more vulnerable with increasing computing power, and may become obsolete with the advent of quantum computing.

There are a number of points in a system at which a side-channel attack may be implemented. Analysis of the device encrypting the communication or analysis of the device decrypting the communication will provide information that may assist decoding the communication. For example, monitoring the power use of an encryption/decryption device or measuring how long certain processor tasks take to complete can provide information to assist in breaking a code.

As will be apparent, however, reading the communication is simpler if the key is available as this by-passes the encryption algorithm all together. In the above example of a one-time key pad, even if the specific key code from the pad is not known, the number of possible keys is limited to those in the pad. Accordingly, a system can be particularly vulnerable while key codes are being distributed to the various transmitters and receivers.

One way to strengthen security of an encryption system is employ a quantum key distribution system to facilitate communication between a transmitter and a receiver. Quantum Key Distribution (QKD) capitalises on the quantum properties of a distribution media to safeguard the information transmitted. As an observation of the distribution media will affect the quantum state, it is possible to determine whether an eavesdropper has observed the media during transmission between Alice and Bob. A signal can then be sent to Alice and/or Bob that the transmission is not secure.

The BB84 protocol is an example of a QKD protocol in which Alice (transmitter) generates and transmits a photon to Bob (receiver). The photon is generated based on the desired bit value (i.e. ‘1’ or ‘0’) and one of two random ‘bases’ (each basis being a pair of orthogonal quantum states). A string of such photons can be used to transmit a random quantum key. To retrieve the key codes, Bob randomly selects a ‘basis’ for each photon and performs a measurement. Once all photons have been measured, Alice transmits the basis used to send each photon, and Bob transmits the basis selected to measure each photon (this can be over a conventional communication channel). The photons where Bob has incorrectly guessed the basis are discarded, and the remaining photons (bits of information) create a shared key code. Advantageously, if Eve has gained any information regarding the photons transmitted from Alice to Bob, errors will be present in Bob's measurements. Hence, if the number of bits differ (i.e. if too many photons are discarded), Alice and Bob abort the use of that particular key code and start again.

While techniques such as use of the BB84 protocol give improved protection, they can still be subject to ‘side-attacks’, whereby other weaknesses in the key distribution system are exploited to allow unauthorised access to the key data. For example, in a fibre-optic network, the photon attenuation can limit the range over which the quantum keys can be distributed to around 100 km. Beyond that range, some form of relay or repeater is required. Relaying the key code beyond the approximate 100 km range using classical relays will suffer from the same issues as classical encryption techniques. QKD over fibre-optic networks is therefore generally limited to urban areas.

In the field of astronautics, cryptography is used to protect telemetry transmitted from space vehicles to the ground and telecommands transmitted from the ground to space vehicles in order to avoid an adversary obtaining data about the status of the space vehicle or issuing unauthorised commands to it. Currently, methods for securing satellite telemetry transmissions against third party interception rely on the difficulty of intercepting periodically uploaded random number generation “seeds” for use in the cryptographic processing units within the spacecraft and at a secure ground station. However, these methods are open to eavesdropping, and are not demonstrably secure. Thus, the exchange of shared keys is subject to the same problems as those faced in terrestrial cryptographic applications.

Accordingly there is a need in the art for enhancing the protection of the communications across a space vehicle (or satellite) based quantum key distribution system. There is particularly a need to enhance protection for communications between the space vehicle and its authorised ground operator.

### Means for Solving the Problem

To overcome the problems detailed above, the inventors have devised novel and inventive control apparatuses and satellites. A broad description will be given of specific aspects of the invention. Preferred features of the specific aspects are set out in the dependent claims.

A control apparatus for a satellite comprising a command generator to generate tracking, telemetry and command, TT&C, instructions for the satellite; an encryptor to encrypt TT&C instructions using a common quantum encryption key shared with the satellite; and a transmitter to transmit the encrypted TT&C instructions to the satellite. Advantageously, the control apparatus is able to securely transmit TT&C information, such as satellite commands, to the satellite.

Preferably, a control apparatus comprises an optical receiver adapted to receive a stream of photons from the satellite, wherein the stream of photons is representative of an encryption key; a beam decoder to determine an encryption key from a received stream of photons. More preferably, a control apparatus is a ground based control apparatus.

In some embodiments, a control apparatus comprises a key sifter adapted to receive information regarding a corresponding encryption key stored on the satellite and determine that bits within the decoded encryption key do not perfectly correspond to bits within the corresponding encryption key. The key sifter is adapted to communicate with the satellite to remove bits from the decoded encryption key that do not perfectly correspond to bits within the corresponding encryption key to create a common encryption key. Including a key sifter improves the privacy and security when establishing a common quantum key between a control apparatus and a satellite.

In some embodiments, the control apparatus comprises a key management system for storing the common encryption key. The control apparatus can therefore communicate with a satellite in situations where a conventional communications link can be established but an optical link cannot be established.

More preferably, the control apparatus comprises a command encryptor, wherein the command encryptor is adapted to receive commands intended for transmission to a satellite, retrieve an encryption key associated with the satellite and to create an encryption command.

In an embodiment, there is provided a satellite adapted to communicate with a control apparatus, comprising a command and telemetry subsystem to generate tracking, telemetry and command, TT&C, information for the satellite; an encryptor to encrypt TT&C instructions using a common quantum encryption key shared with the control apparatus; and a transmitter to transmit the encrypted TT&C instructions to the control apparatus. Advantageously, the satellite is able to securely transmit TT&C information, such as satellite telemetry data, to the control station.

Preferably, a satellite comprises a photon source for producing a stream of photons; a cryptographic key generator for encoding the stream of photons based on a generated quantum encryption key; and an optical transmitter for transmitting at least a portion of the encoded stream of photons to a control station.

More preferably, the cryptographic key generator is adapted to split the stream of photons to create a first stream of entangled photons and a second stream of entangled photons, such that photons in the first stream of entangled photons are entangled with corresponding photons in the second stream of entangled photons. Still more preferably, the optical transmitter is adapted to transmit the second stream of entangled as the at least a portion of the encoded stream of photons to the control station.

In some embodiments, a satellite comprises a key sifter adapted to receive information regarding an encryption key stored on the control station and determine that bits within the generated encryption key do not perfectly correspond to bits within the encryption key stored on the control station. The key sifter is further adapted to communicate with the control station to remove bits from the generated quantum encryption key that do not perfectly correspond to bits within the encryption key stored on the control station to create the common encryption key. Including a key sifter improves the privacy and security when establishing a common quantum key between a satellite and a control apparatus.

In some embodiments, a satellite comprises a key management system for storing the common quantum encryption key.

In some embodiments, a satellite comprises a command decryptor adapted to receive an encrypted command from a control station, retrieve an encryption key from the key management system, decrypt the encrypted command using the encryption key and forward the decrypted command to a command and telemetry subsystem.

In some embodiments, a satellite is adapted to distribute a communication client quantum key to a first communication client and to a second communication client.

In some embodiments, a control apparatus for a satellite comprises means for encrypting a tracking, telemetry and command link using a quantum encryption key.

In some embodiments, a satellite comprises means for encrypt a tracking, telemetry and command link using a quantum encryption key.

In some embodiments, a satellite comprises means for producing a stream of photons; means for encoding the stream of photons based on a generated quantum encryption key; and means for transmitting the encoded stream of photons to a control station.

In an embodiment of the present invention, a system comprise a control apparatus as above described and a satellite as above described. For example, the system may comprise a control apparatus for a satellite comprising a command generator to generate tracking, telemetry and command, TT&C, instructions for the satellite; an encryptor to encrypt TT&C instructions using a common quantum encryption key shared with the satellite; and a transmitter to transmit the encrypted TT&C instructions to the satellite. The system may also comprise a satellite adapted to communicate with a control apparatus, comprising a command and telemetry subsystem to generate tracking, telemetry and command, TT&C, information for the satellite; an encryptor to encrypt TT&C instructions using a common quantum encryption key shared with the control apparatus; and a transmitter to transmit the encrypted TT&C instructions to the control apparatus. Preferably, a system may comprise a first communication client and a second communication client.

Various embodiments and aspects of the present invention are described without limitation below, with reference to the accompanying figures.

### BRIEF DESCRIPTION OF THE DRAWINGS

FIG. 1 depicts a satellite based quantum key distribution system.

FIG. 2 depicts a satellite based quantum key distribution system.

FIG. 3 is a block diagram of a satellite according to aspects of the present invention.

FIG. 4 is a block diagram of a control apparatus according to aspects of the present invention.

### DETAILED DESCRIPTION OF A PREFERRED EMBODIMENT

The following description relates to a satellite based quantum key distribution (QKD) system. A satellite (or space vehicle) based QKD system minimises the need for the repeaters, or “Trusted Nodes” that are required by QKD fibre networks. A satellite is used to distribute a quantum key to a transmitter (Alice) and a receiver (Bob) with whom the transmitter wishes to communicate.

The system 1 described herein includes a satellite (or space vehicle) 200 and a control station 100. The satellite 200 and the control station 100 are operable to communicate via a wireless communications channel. The wireless connection is encrypted using quantum key data generated on-board the satellite 200 and delivered to the control station 100 using a Quantum Key Distribution protocol and an optical channel. Advantageously, this prevents unauthorised access to both the satellite telemetry and command channels.

### Quantum Key Distribution System

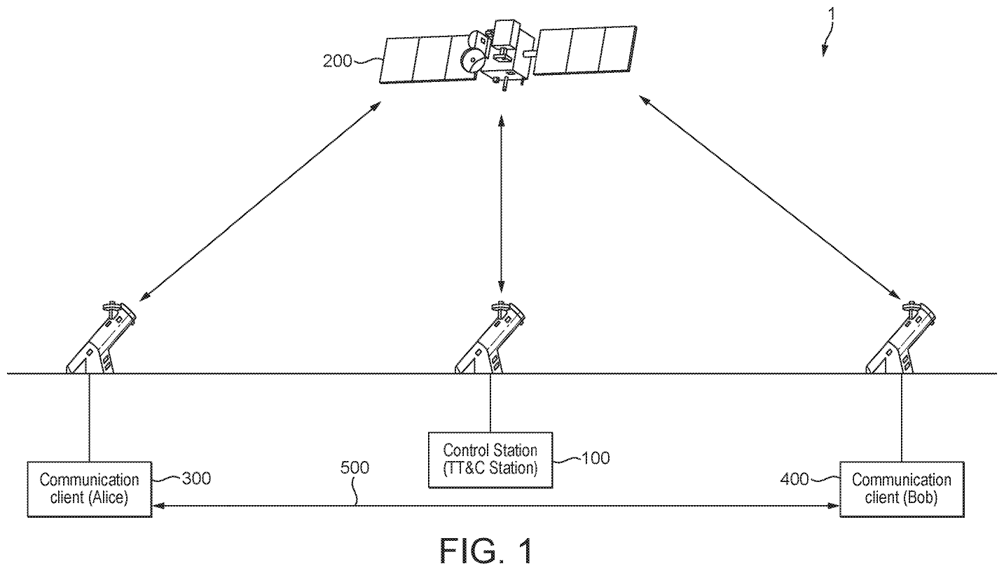

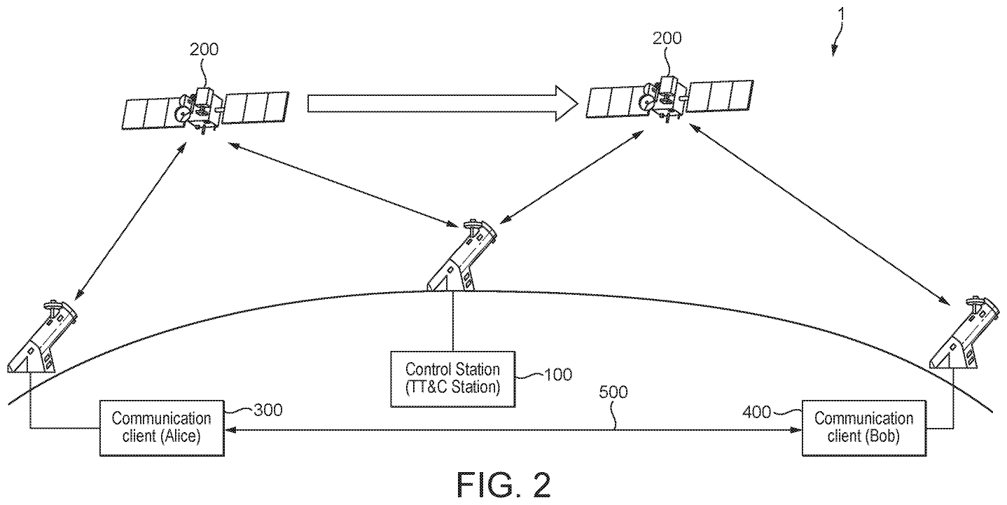

With reference to FIGS. 1 and 2, the QKD system 1 allows two communication clients to communicate securely. FIG. 1 shows a situation where the two communication clients are both in range of the satellite at the same time, and FIG. 2 shows a situation where the two communication clients come into range of the satellite at different times during the orbit of the satellite. FIG. 1 may relate to a satellite in geostationary orbit or a situation in which the satellite moves relative to the earth's surface. FIG. 2 relates a situation in which the satellite moves relative to the earth's surface.

In a satellite system, a control station 100 communicates with a satellite 200 in Earth Orbit to provide tracking, telemetry and command (TT&C) functionality. This may include, for example, ensuring the satellite 200 has a desired longitude and latitude, and is at a desired height. TT&C determines the pointing of the satellite from time to time which controls to which customers keys are transmitted. Communications between the control station 100 and the satellite 200 relating to TT&C functionality typically takes place over a conventional or classical channel (e.g. a radio frequency channel).

In the QKD system shown in FIG. 1, the satellite 200 is able to distribute a quantum key to a first communication client 300 and a second communication client 400, sometimes referred to as ‘Alice’ 300 and ‘Bob’ 400 respectively. In the system shown in FIG. 1, a key is generated on the satellite, and used to encode data into the quantum spin state of photons that are directed in a laser beam to the first communication client 300 and a second communication client 400. The photons will all be part of entangled pairs, with one of each pair being transmitted in a beam to the first communication client 300 and the other of each pair being transmitted in a beam to the second communication client 400. Once received, the communication clients detect the quantum information and through a key agreement process determine the key, which can then be used to encrypt transmissions over a conventional communication channel 500 (e.g. a phone line, an internet connection, a radio frequency transmission, a fibre optic network, etc.) between the first communication client 300 and the second communication client 400.

The portion of photons received by an optical detector at the client sites 300, 400 will vary depending on atmospheric conditions (the photons will be subject to diffraction effects, for example). Accordingly, it is preferable that the one or more satellites are placed in Low Earth Orbit (LEO). In some arrangements, one or more satellite is placed in LEO while at least one other satellite is placed in Medium Earth Orbit (MEO) or in High Earth Orbit (ISO).

The distribution of the key from the satellite 200 to the first communication client 300 and the second communication client 400 can occur using one of two general techniques. Firstly, key distribution can occur in real-time when both the first communication client 300 and the second communication client 400 are in the satellite's field of view simultaneously, as shown in FIG. 1. Secondly, key distribution may employ a “store and forward” technique whereby key data is transmitted to one user and then stored on-board the satellite 200 until it can be transmitted to the second user when the satellite 200 makes a visible overpass of that second user, as shown in FIG. 2.

With the described QKD system 1, the number of trusted nodes (e.g. ground based repeaters and relay nodes) can be reduced. Having fewer trusted nodes in the system reduces the possibility for side-attacks to the system.

Even when the need for trusted nodes is reduced, there will still be at least the control station 100 as a physical component on the ground, in addition to the first and second communication clients 300, 400. For example, a satellite 200 according to the present arrangement is controlled in orbit by the transmission of telecommands from the TT&C ground station 100 to the satellite 200, and the satellite 200 transmits telemetry information to the TT&C ground station 100, via a TT&C link (TT&C channel). The TT&C link is typically a classical radio frequency link.

Unauthorised access through the TT&C link could allow a third party to take control of the satellite bus and/or the payload, thus compromising the management processes of the QKD system (in some instances, the satellite could be removed from orbit if the TT&C link is compromised). The third party could also gain unauthorised access to key data on the satellite by controlling the pointing of the bus.

To protect the TT&C link, and hence reduce the possibility of side-attacks, satellite based QKD systems conventionally use classical encryption protocols (such as RSA) to encrypt the commands and associated telemetry between the satellite 200 and the control station 100. However, even with such encryption, there remains the possibility that the encryption could be broken. Indeed, it is theorised that once quantum computing becomes established, the level of protection afforded by classical encryption protocols will be inadequate thereby rendering a satellite system vulnerable to side attack.

In the preferred embodiment, the TT&C link is protected by a quantum encryption technique. More particularly, transmission of commands from the control station 100 to the satellite 200 is protected by quantum encryption. Similarly, transmission of telemetry information from the satellite 200 to the control station 100 is protected by quantum encryption.

Preferably, an encryption key (quantum key) is generated on board the satellite 200 and sent to the TT&C ground station 100. The TT&C ground station 100 can uses the received quantum key to encrypt telecommands, which control the satellite 200 and its payload.

Applying a quantum encryption technique to the command transmissions from the control station 100 to the satellite 200, and/or to the telemetry transmissions from the satellite 200 to the control station 100, further reduces the potential for side attack by the mechanism of establishing a false telecommand link.

### Satellite

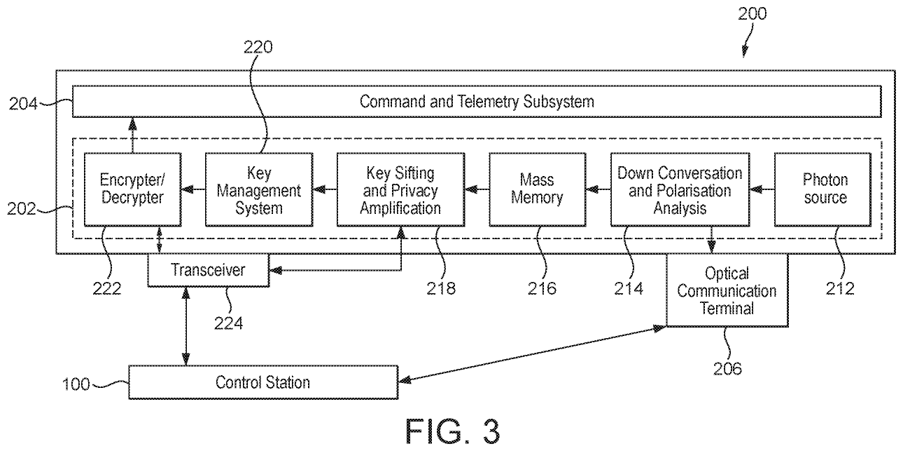

As shown in FIG. 3, a satellite 200 comprises at least two sub-systems; a satellite platform 204 to perform general bus management functions, and a quantum encryption subsystem 202. In the preferred embodiment, the quantum encryption subsystem 202 comprises a photon source 212, a cryptographic key generator (or polarisation analyser) 214, a memory (or mass memory) 216, a key sifter 218, a key manager (or key management system) 220 and a encrypter/decrypter (or encryption/decryption unit) 222. A satellite 200 according to the preferred embodiment further comprises an optical communication terminal 206. The optical communication terminal 206 may comprise an optical transmitter and an optical receiver. In some aspects, the optical communication terminal 206 is an optical transceiver. The optical communication terminal 206 is adapted to transmit photons from the photon source or generator 212, as processed by the cryptographic key generator 214, to a control station 100 or other ground station. The transceiver 224 is able to transmit and receive using a conventional communication channel (for example a radio frequency channel). FIG. 3 also shows the satellite 200 having a transmitter/receiver (transceiver) 224. The transceiver 224 is able to transmit and receive using a conventional communication channel (for example a radio frequency channel). In some aspects, the key sifter 218 and the encrypter/decrypter 222 can communicate with the control station 100 using the transceiver 224.

The photon generator 212 may be a weak coherent photon source that utilises attenuated laser pulses (for example, the pulse duration is 1 ns, or at least in the order of 1 ns, with a repetition rate of approximately 1 GHz) from a laser diode in order to achieve the desired low mean photon number (in the preferred embodiment, on the order of 0.1 to 1.0 per pulse). In some arrangements, an array of lasers diodes and semiconductor amplifiers are used to encode for four different (linear) polarisation states to generate the cryptographic key. The polarisation states typically have polarisation vectors along 0°, 45°, 90°, and 135°. The beams of the individual laser diodes (having polarisation vectors along 0°, 45°, 90°, and) 135° are combined and launched into a single mode optical fibre for transmission to the cryptographic key generator 214. In some aspects, the photon source 212 can include an entangled photon generator and a weak coherent photon generator thereby enabling a number of different QKD protocols to be utilised by the same photon source.

The cryptographic key generator 214 receives the generated photons from the photon generator 212, and analyses the polarisation of the generated photons. Preferably, the generated photons undergo a parametric down-conversion process in the cryptographic key generator 214. The photon beam received from the photon generator 214 is split using a crystal (not shown). Photon pairs resulting from the splitting of the photon beam have combined energy and momenta and are said to be ‘entangled’.

The cryptographic key generator 214 then generates a stream of random numbers for each pulse of the laser. The generated random number determines which of the four polarisation vectors (i.e. 0°, 45°, 90°, and 135° noted above) is to be sent to the control station 100, with the corresponding photon of the entangled pair being polarisation analysed on the satellite 200. The split photon beam is filtered based on the random number stream to produce an encoded photon beam that will be transmitted to the control unit 100 and a corresponding photon beam for analysis on the satellite 200. In this way, the random number is used to encode the photon beam. For example, a ‘0’ in the random number may be encoded with a rectilinear basis (i.e. with polarisation vectors 0° and 90°), and a ‘1’ may be encoded with diagonal basis (i.e. with polarisation vectors 45° and 135°). In other examples, the encoding basis can be the other way around (i.e. ‘0’ has diagonal basis and ‘1’ has rectilinear basis).

In an example where a ‘0’ may be encoded with a rectilinear basis, and a ‘1’ may be encoded with diagonal basis, and the random number is generated as 11010, the polarisation vectors of successive photons in the beam may be selected (or filtered) as 135°, 45°, 0°, 45°, 90° to form the encoded beam. The photons with those polarisation vectors can be sent to the control station 100. The photons entangled with each one of the selected (or filtered) successive photon will have the corresponding vectors (i.e. 45°, 135°, 90°, 135°, 0° based on the example given above) and remain as the corresponding beam to be analysed on the satellite 200.

The encoded photon beam is then passed to the optical communication terminal 206 for transmission to the control station 100. The corresponding photon beam is polarisation analysed on the satellite 200, preferably in the cryptographic key generator 214. The random number resulting from the analysis is then passed to the mass memory 216 and stored. The resulting random number will correspond to that at the control station 100 once the encoded photon beam has been decoded. At this point, the satellite 200 and the control station 100 therefore share an encryption key, unless there are, for example, transmission errors.

Practically, it is unlikely that the transmission of the encoded beam to the control station 100 will be without error. In the preferred embodiment, the control station 100 and the satellite 200 therefore carry out a key sifting process and/or a privacy amplification process to determine a common encryption key. The key sifting and privacy amplification processes are described in more detail below.

The common encryption key is transmitted to the key management system 220 for storing. The common encryption key can be extracted and used by the encrypter/decrypter 222, which can use the common encryption key to encrypt information (such as telemetry information) to be sent to the ground station 100 and to decrypt information (such as commands) received from the ground station 100. FIG. 3 shows an aspect in which information is encrypted and decrypted as needed by an encrypter/decrypter 222. In other aspects, the satellite 200 includes a separate encrypter and decrypter.

An encrypted command can be received by the satellite 200 over a classical communication channel (such as an optical or radio frequency channel). The encrypted command is received by the command decryptor 222, which subsequently retrieves the common encryption key from the key management system 220. Once the common encryption key has been retrieved, the command decryptor 222 decrypts the encrypted command. The resulting command is then passed to the command and telemetry sub system 204 to be actioned.

The satellite 200 is also capable of transmitting information to the control station 100. For example, the satellite 200 will transmit tracking and telemetry information to the control station 100. The command and telemetry subsystem 204 generates the information for transmission. The information for transmission is received by the encrypter/decrypter 222, which then retrieves the common encryption key from the key management system 220. The encrypter/decrypter 222 uses the common encryption key to encrypt the information, and the resulting encrypted information can be sent to the control station 100 via a classical communication channel.

### Control Station

A control station (or TT&C station) 100 commands one or more satellites 200 from the ground via command and control instructions transmitted to the or each satellite 200. Similarly, the TT&C station 100 monitors status and operations of the one or more satellites 200 based on received telemetry information. Typically, this is done through a control plane (also termed ‘TT&C links’) that is usually separate to the payload communications channels, and sometimes operates at a different frequency to that used by the satellite's payload for communications. Such TT&C stations 100 may be located at sites on the ground, which transmit commands and receive telemetry from satellites. Such sites are known as Telemetry, Tracking and Command (TT&C) stations.

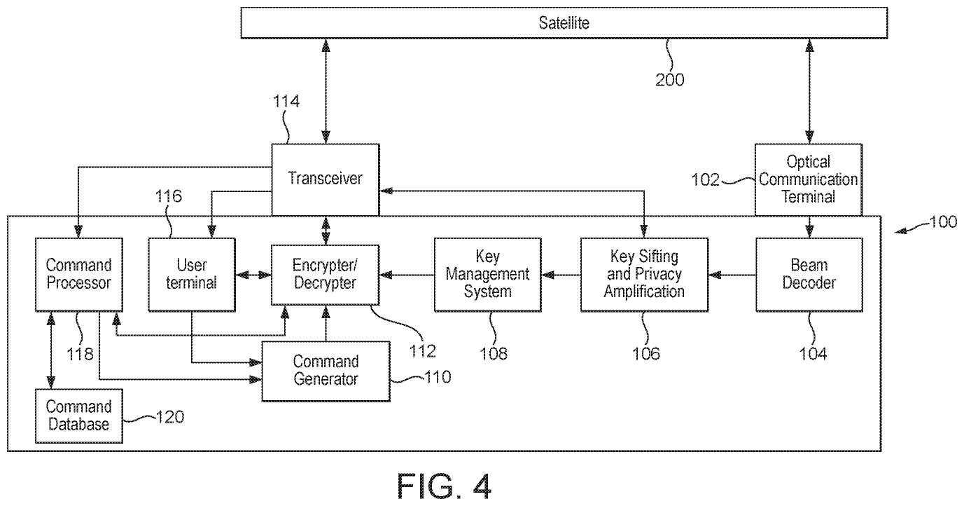

The TT&C station 100 shown in FIG. 4 comprises optical communication terminal 102, a beam decoder 104, a key sifter 106, a key management system 108, a command generator 110, an encrypter/decrypter 112, a transmitter/receiver (transceiver) 114, a user terminal 116, a command processor 118, and a command database 120. In the preferred embodiment, the control station 100 is a ground based control station 100. The optical communication terminal 102 is adapted to receive photons from the satellite 200. In some aspects, the optical communication terminal 102 may comprise an optical transmitter and an optical receiver. In some aspects, the optical communication terminal 102 is an optical transceiver. FIG. 4 shows an aspect in which information is encrypted and decrypted as needed by an encrypter/decrypter 112. In other aspects, the ground station 100 includes a separate encrypter and decrypter.

When establishing a common encryption key between the satellite 200 and the control apparatus (TT&C station) 100, an encoded photon beam is received at the optical communication terminal 102 and passed to the beam decoder 104. In the preferred embodiment, the received photon beam is an encoded beam transmitted from the optical communication terminal 206 on the satellite 200 as shown in FIG. 3. As discussed above, the satellite 200 retains and analyses a photon beam corresponding to the encoded photon beam received by the TT&C station 100.

The beam decoder 104 analyses (or decodes) the received beam to determine an associated bit stream, which represents an encryption key. In some practical situations, the bit stream determined by the beam decoder 104 is not perfectly aligned with the encryption key as determined on the satellite 200 (preferably by the cryptographic key generator 214). The control station 100, in the arrangement shown in FIG. 4, includes a key sifter 106, which can communicate with a key sifter 218 on the satellite 200 to establish a common encryption key without errors. The key sifters 106 may also perform a privacy amplification process to improve security in the event of errors in the bit stream. Further details regarding the key sifting process and privacy amplification can be found below.

Once a common encryption key is agreed between the control key sifter 106 and the satellite key sifter 218, the control key sifter 106 passes the common encryption key to the key management system 108. The key management system 108 stores the common encryption key ready for extraction and use by the encrypter/decrypter 112. In embodiments where the control station 100 controls a plurality of satellites 200, the key management system 108 can include an indication of the satellite 200 in metadata associated with the common encryption key.

Once the common encryption key is stored in the key management system 108, the control station 100 is ready to communicate TT&C information with the satellite 200.

As shown in FIG. 4, the control station 100 can include a user terminal 116 and/or a command processor 118 able to communicate with a command database 120.

In aspects where a user terminal 116 is present, a user may input instructions to the user terminal 116, which are then transmitted to the command generator 110. The command generator 110 converts the input instructions from the user terminal into a command having a format that can be processed by the satellite 200, and transmits the command to the encrypter/decrypter 112. In some aspects, the user terminal 116 can convert the user input instructions into a command having a format that can be processed by the satellite 200 and can pass a command directly to the encrypter/decrypter 112. It is preferred that the user terminal 116 is located at the control station 100 to minimise the possibility of an eavesdropper intercepting the transmitted command. In some aspects, the user terminal 116 can be remote from the control station 100 and can communicate with the command generator 110 and/or the encrypter/decrypter 112 as appropriate by a wired or a wireless communication link.

In a preferred embodiment, the control station 100 comprises a command processor 118 and a command database 120, which contains a number of command templates. The command processor 118 is able to receive input information regarding the satellite 200 (for example, location and/or telemetry information from the satellite 200). In some aspects, such as that shown in FIG. 4, input information regarding the satellite 200 is received via the transmitter/receiver 114. In some aspects, input information regarding the satellite 200 is received via a dedicated receiver.

The command processor 118 compares the received input information with expected input information called from a command database 120. As a result of the comparison, the command processor 118 may determine whether action is required. That determination can be based on predetermined threshold values. For example, the command processor 118 may determine that the orbit of the satellite 200 is at or below a predetermined threshold height or is more than a predetermined tolerance away from an expected longitude and/or latitude or needs to be altered in order to accommodate communication client locations whose elevation angle exceeds to pointing range of the transmitter alone.

If it is determined that action is required, the command processor 118 retrieves a relevant command template from the command database 116 and, based on the command template and the received information regarding the satellite 200, generates a command. In an example where it is determined that a satellite 200 is at or below a threshold altitude, the command processor 200 may retrieve a command template relating to adjusting (or increasing) altitude from a command database 120. Once retrieved, the command processor 118 sets variables within the command template, such that the resulting command is for the satellite 200 to increase altitude by a given amount.

Once generated, the command is transmitted to the encrypter/decrypter 112. In some aspects, the command is first transmitted to a command generator 110 to be placed in a format readable by a processor on-board the satellite 200 to which the command is directed. For example, if a control station 100 controls a plurality of satellites 200, each satellite 200 may use a different operating system. The command generator 110 determines the satellite 200 for which the command is intended (i.e. the destination satellite), and formats the command accordingly.

Once the encrypter/decrypter 112 has received the command (whether from a user terminal 116, a command processor 118 or a command generator 110), the destination satellite is identified. An indication of the destination satellite 200 may be received with the command if the destination satellite 200 has been determined previously. Metadata of the received command may be analysed to identify the destination satellite 200. Once the encrypter/decrypter 112 has made the identification, it retrieves the associated encryption key from the key management system 108. The associated encryption key is then used to encrypt the command, and the encrypted command is transmitted to the satellite 200 via the transmitter/receiver 114.

The control station 100 is also capable of receiving encrypted information from the satellite 200. For example, the satellite 200 may encrypt and transmit telemetry information. The encrypted information is received at the communication terminal 114 of the control station 100, and transmitted to the encrypter/decrypter 112. The encrypter/decrypter 112 retrieves the common encryption key from the key management system 108, and use that key to decrypt the encrypted information. Once decrypted, the information can be passed to the relevant location, for example the user terminal 116 if user input is required or the command processor 118 if an automated response is required.

Key Sifting and Privacy Amplification

A key sifting process occurs between the control key sifter 106 and the satellite key sifter 218 during the process of establishing a common encryption key between the ground station 100 and the satellite 200. The control key sifter 106 transmits, to the satellite key sifter 218, the bit stream resulting from processing of the received photon beam (encoded photon beam) by the beam decoder 104. Alternatively, or in addition, the satellite key sifter 218 transmits, to the control key sifter 106, the bit stream resulting from processing of the photon stream (corresponding beam) by the cryptographic key generator 214.

The key sifter that receives the bitstream then determines which bits of the received bit stream are perfectly correlate with the equivalent bits at the platform (control device or satellite) itself Δny bits that do not perfectly correlate with their equivalent bits in the corresponding photon beam on the satellite are discarded (as are those equivalent bits in the corresponding photon beam on the satellite). The remaining bits form a common encryption key between the control station 100 and the satellite 200. For example, the satellite key sifter 218 can determine which bits of the bit stream received from the control station 100 are perfectly correlated with the equivalent bits from the photon stream processed by the cryptographic key generator 214. Similarly, the control key sifter 106 can determine which bits of the bit stream received from the satellite 200 are perfectly correlated with the equivalent bits from the photon stream processed by the beam decoder 104.

The communication between the control key sifter 106 and the satellite key sifter 218 can be over a conventional (or classical) communication channel. In some arrangements, the control key sifter 106 communicates with the satellite key sifter 218 via the transmitter/receiver 114. In some arrangements, the control key sifter 106 communicates with the satellite key sifter 218 via a dedicated key sifter transmitter/receiver.

In some aspects, the key sifter 106 can also perform a privacy amplification, preferably after key sifting. In the privacy amplification, the common encryption key is compressed by an appropriate factor to reduce the information of the eavesdropper (Eve). The compression factor depends on the error rate. A higher error rate allows more information regarding the key to be available to a potential eavesdropper, and requires a higher compression factor to be applied to the encryption key be secure.

Privacy amplification, such as described above, works up to a maximum error rate. Above this threshold, it is possible that an eavesdropper has too much information regarding the bit stream to allow the control station 100 and satellite 200 to produce a secure key. Accordingly, it is desirable to minimise the intrinsic error rate of a quantum key distribution system—this can be achieved through the system design and the choice of components. As no key information is exchanged during key sifting and privacy amplification, both processes can take place over an optical or radio frequency link (i.e. a classical channel).

### QKD Between Satellite and Control Station

Two types of communications links are utilised. The first is a wireless communications link (using, for example, a radio frequency) which supports both the TT&C channel and the classical communication channel used for payload operations such as key sifting and privacy amplification. The second is an optical link which consists of a laser beacon signal and the QKD distribution link. In some arrangements the classical communications channel may be replaced by an optical communications channel utilising the functionality of the optical transmitter and optical receiver.

When a satellite 200 passes over an authorised control station 100 (i.e. is able to communicate directly with the control station 100), an attempt can be made to establish a QKD distribution link between the satellite 200 and the control station 100 to allow transmission of key data in photonic form. In an preferred embodiment, establishment of a QKD distribution link is attempted every time the satellite 200 passes over an authorised control station 100. A new shared quantum key will therefore be established as often as possible, thereby reducing the chances of an eavesdropper obtaining a key by accessing a memory of the control station 100 or the satellite 200. Preferably, the satellite 200 initiates the attempt to establish a QKD distribution link. In some aspects, the control station 100 initiates the attempt to establish a QKD distribution link.

In some aspects, establishment of a QKD distribution link can occur at predetermined time periods. This can be of particular use with geostationary communication satellites.

In the preferred arrangement, the link is established using satellite ephemeris data (i.e. current position, predicted position, and status or health of the satellite) and control station 100 location information to calculate the pointing instructions to point the optical transmitter 206 of the satellite 200. The control station 100 also uses satellite ephemeris information, particularly location information (both current and predicted) to calculate pointing information for the optical receiver 102.

Once the satellite optical communication terminal (optical transceiver) 206 is pointed at the control station 100, it emits a laser beacon signal to be received by the control station optical communication terminal (optical transceiver) 102. Upon receipt of that laser beacon signal, the optical transceiver 102 emits a laser beacon signal which is received at the satellite 200 to establish that the optical communication terminals are aligned and ready for transmission of a photon stream. The two laser beacons are then used by the optical communication terminal 206 of the satellite 200 and the optical communication terminal 102 of the control station 100 to establish a closed loop tracking scheme enabling the QKD distribution link to be reliably established.

Once a QKD distribution link has been established, the satellite's 200 QKD payload 202 creates key data following one of a range of QKD protocols using a photon source 212. In some aspects, the QKD distribution link may be pre-existing, if the satellite 200 is in geostationary orbit for example (even with a satellite in geostationary orbit, the optical communication terminal alignment process may still occur to ensure a good link).

In some aspects, key data is created using the E91 protocol, in which a UV Pump Laser is used to stimulate an entangled photonic transceiver (which together form the photon source 212 and generate pairs of entangled photons at a rate suitable to ensure sufficient key data for protection of the telemetry and telecommand links of the satellite 200 in real time. The entangled photons are directed into two separate optical paths, such that one photon of an entangled pair follows one path and the other photon of the entangled pair follows the other path, thereby resulting in a first stream of entangled photons and a second stream of entangled photons (with photons in the first stream being entangled with photons in the second stream). For example, assuming the first generated photon pair has a vertical polarisation, the 0° photon is directed to a first optical path and the 180° photon is directed to a second optical path. Similarly, assuming the second generated photon pair has a horizontal polarisation, the 90° photon can be directed to one of the first and second paths, and the 270° photon can be directed to the other of the first and second paths.

In the preferred arrangement, a first optical path (the control station path) passes through the optical communication terminal 206 and onward to the optical communication terminal 102 of the control station 100. A second optical path (the satellite path) passes through the polarisation analysis system 214 on board the satellite 200. This is repeated for all of the photon pairs emitted by the photon source 212.

The satellite 200 and the control station 100 analyse photons received along their respective optical paths to establish a set of key data. The satellite polarisation analyser 214 and the control station beam decoder 104 independently and randomly choose from two different bases (i.e. orientations of their analysers) to measure the polarisations of each photon received in order. For example, the satellite polarisation analyser 214 may independently and randomly select 0°, 90°, 90°, 90°, 0° as the bases to analyse the first 5 photons in the satellite path, whereas the control station beam decoder 104 may independently and randomly select 0°, 0°, 90°, 0°, 90° to analyse the first 5 photons in the control station path. Of course, the first 5 photons in the satellite path will be the entangled pairs of the first 5 photons in the control device path.

The selection of bases that will be used to analyse the photons in the satellite path (the first stream of entangled photons) is passed to the satellite key sifter 218, and may be stored in the satellite memory 216. The selection of bases that will be used to analyse the photons in the control station path (the second stream of entangled photons) is passed to the control station key sifter 106.

The satellite key sifter 218 and the control station key sifter 106 communicate with each other to establish which of the randomly selected bases correspond, and which do not. Those that do not correspond are allocated to a first group, whereas those that do correspond are allocated to a second group. As the randomly selected bases contain no information regarding the encryption key, the satellite key sifter 218 and the control station key sifter 106 can communicate over a classical channel. Preferably, the key sifters 106, 218 communicate using the respective transceivers 114, 224. In the example above (wherein the satellite selected bases 0°, 90°, 90°, 90°, 0° and the control device selected bases 0°, 0°, 90°, 0°, 90°), the second, fourth and fifth selections are in the first group and the first and third selections will be in the second group.

The photons in the satellite path with the same orientation as the randomly selected base of the satellite polarisation analyser 214 pass through the satellite polarisation analyser 214, whereas those with a different orientation are stopped. The polarisation of the photons in the satellite path has now been analysed and the results are sent to the satellite key sifter 218, and may be stored in the satellite memory 216. Similarly, photons in the control device path with the same orientation as the randomly selected base of the control station beam decoder 104 pass through the control station beam decoder 104, whereas those with a different orientation are stopped. The results of the polarisation analysis of the control device path are sent to control station key sifter 106.

Once the photon beams on the satellite 200 and at the control station 100 have been polarisation analysed, the satellite key sifter 218 and control station key sifter 106 exchange measurements resulting from the first group of polarisation bases (i.e. the group of bases that did not correlate between the satellite and the control station). The satellite key sifter 218 and control station key sifter 106 then determine if the measurements resulting from the first group of bases are correlated by calculating a correlation coefficient and determining if the correlation coefficient is an expected value (according to Bell's Theorem, the correlation coefficient should be −2√2, but there a tolerance may be built into the calculation to account for inaccuracies in the measurements). If the correlation coefficient is the expected value for measurements relating to the first group of bases, Bell's Theorem indicates that the measurements in the second group will be anti-correlated and can therefore be used to produce a secret key between the satellite 200 and control device 100. If the correlation coefficient is below the expected value, it can be assumed that observations have been made of some of the photons and therefore that the transmission of the photon streams was not secure. The process of establishing a common key at the satellite 200 and the control station 100 will therefore begin again.

After a common key has been established by the control station key sifter 106 and the satellite key sifter 218, the key is passed to the respective key management systems 108, 220 for storage. The control station key management system 108 and the satellite key management system 220 now have the same key stored therein.

With a common key stored in the control station key management system 108 and the satellite key management system 220, an encryption process can begin. In the preferred embodiment, the command encryptor 112 at the control station 100 receives command data to be transmitted to the satellite 200. The command data can be received from a command generator 110 or a user terminal 116. On receipt of the command data, the command encryptor 112 requests a key from the key management system 108. The command encryptor 112 receives the key associated with the satellite 200 to which the command data is destined in response to the request. The command encryptor 112 uses the received key to encrypt the command data, and transmits the encrypted command data to the control station transceiver 114, which in turn transmits the encrypted command data to the satellite 200.

### Other Aspects, Embodiments and Modifications

In some aspects, the TT&C device 100 includes a photon source. In such an arrangement, the TT&C device 100 initiates the process for establishing a shared TT&C link with a satellite 200.

Many other variants and embodiments will be apparent to the skilled reader, all of which are intended to fall within the scope of the invention whether or not covered by the claims as filed. Protection is sought for any and all novel subject matter and combinations thereof disclosed herein.

1. A control apparatus for a satellite comprising:
a command generator to generate tracking, telemetry and command (TT&C) instructions for the satellite;
an encryptor to encrypt TT&C instructions using a common quantum encryption key shared with the satellite; and
a transmitter to transmit the encrypted TT&C instructions to the satellite.

2. The control apparatus of claim 1 further comprising:
an optical receiver adapted to receive a stream of photons from the satellite, wherein the stream of photons is representative of an encryption key; and
a beam decoder to determine an encryption key from a received stream of photons.

3. The control apparatus of claim 1, wherein the control apparatus is a ground based control apparatus.

4. The control apparatus of claim 1 further comprising:
a key sifter configured to receive information regarding a corresponding encryption key stored on the satellite and determine that bits within the decoded encryption key do not perfectly correspond to bits within the corresponding encryption key,
wherein the key sifter is further configured to communicate with the satellite to remove bits from the decoded encryption key that do not perfectly correspond to bits within the corresponding encryption key to create a common encryption key.

5. The control apparatus of claim 4 further comprising:
a key management system for storing the common encryption key.

6. The control apparatus of claim 1 further comprising:
a command encryptor, wherein the command encryptor is configured to receive commands intended for transmission to a satellite, retrieve an encryption key associated with the satellite and to create an encryption command.

7. A satellite configured to communicate with a control apparatus, the satellite comprising:
a command and telemetry subsystem to generate tracking, telemetry and command (TT&C) information for the satellite;
an encryptor to encrypt TT&C instructions using a common quantum encryption key shared with the control apparatus; and
a transmitter to transmit the encrypted TT&C instructions to the control apparatus.

8. The satellite of claim 7 further comprising:
a photon source for producing a stream of photons;
a cryptographic key generator for encoding the stream of photons based on a generated quantum encryption key; and
an optical transmitter for transmitting at least a portion of the encoded stream of photons to a control station.

9. The satellite of claim 8,
wherein the cryptographic key generator is configured to split the stream of photons to create a first stream of entangled photons and a second stream of entangled photons, such that photons in the first stream of entangled photons are entangled with corresponding photons in the second stream of entangled photons; and
wherein the optical transmitter is configured to transmit the second stream of entangled as the at least a portion of the encoded stream of photons to the control station.

10. The satellite of claim 7 further comprising:
a key sifter configured to receive information regarding an encryption key stored on the control station and determine that bits within the generated encryption key do not perfectly correspond to bits within the encryption key stored on the control station,
wherein the key sifter is further configured to communicate with the control station to remove bits from the generated quantum encryption key that do not perfectly correspond to bits within the encryption key stored on the control station to create the common encryption key.

11. The satellite of claim 7 further comprising:
a key management system for storing the common quantum encryption key.

12. The satellite of claim 11 further comprising:
a command decryptor configured to receive an encrypted command from a control station, retrieve an encryption key from the key management system, decrypt the encrypted command using the encryption key and forward the decrypted command to a command and telemetry subsystem.

13. The satellite of claim 7 further configured to distribute a communication client quantum key to a first communication client and to a second communication client.

14-16. (canceled)

17. A system comprising:
a control apparatus comprising:
a command generator to generate tracking, telemetry and command (TT&C) instructions for a satellite;
an encryptor to encrypt TT&C instructions using a common quantum encryption key shared with the satellite; and
a transmitter to transmit the encrypted TT&C instructions to the satellite; and
the satellite comprising:
a command and telemetry subsystem to generate tracking, telemetry and command (TT&C) information for the satellite;
an encryptor to encrypt TT&C instructions using a common quantum encryption key shared with the control apparatus; and
a transmitter to transmit the encrypted TT&C instructions to the control apparatus.

18. The system of claim 17 further comprising:
a first communication client and a second communication client.

19. The system of claim 17, wherein the control apparatus is a ground based control apparatus.

20. The system of claim 17, wherein the control apparatus further comprises:
an optical receiver adapted to receive a stream of photons from the satellite, wherein the stream of photons is representative of an encryption key; and
a beam decoder to determine an encryption key from a received stream of photons.

21. The control apparatus of claim 2, wherein the control apparatus is a ground based control apparatus.
